(19) United States
(12) Patent Application Publication
(10) Pub. No.: US 2021/0244228 A1
(43) Pub. Date: Aug. 12, 2021

(54) COOKING APPARATUS

(71) Applicant: StoreBound LLC, New York, NY (US)

(72) Inventors: Evan Marc DASH, New York, NY (US); Rachel DASH, New York, NY (US); Yiyang ZHANG, Brooklyn, NY (US); Shelby SCOTT, New York, NY (US)

(21) Appl. No.: 16/805,295

(22) Filed: Feb. 28, 2020

Related U.S. Application Data
(63) Continuation-in-part of application No. 29/723,678, filed on Feb. 10, 2020.

(51) Int. Cl. A47J 27/04; A47J 36/32; A47J 27/10

(52) U.S. Cl. CPC A47J 27/04; A47J 2027/043; A47J 27/10; A47J 36/32

(57) ABSTRACT

A cooking apparatus for cooking a food item. The cooking apparatus may include a base component and a lid component. The base component includes a reservoir. The lid component may be alterable between a closed state whereby the lid closes an open top end of the reservoir and an open state whereby the reservoir is exposed. A plurality of cups may be positioned in the reservoir of the base component. Each of the cups may have an internal cavity with a first liquid holding capacity. The reservoir of the base component may have a second liquid holding capacity when the plurality of cups are positioned in the reservoir. The second liquid holding capacity is equal to or greater than the first liquid holding capacity so that one of the cups can be filled with liquid and then the liquid poured from the cup into the reservoir without overflowing the reservoir.

### CROSS-REFERENCE TO RELATED APPLICATIONS

The present application is a continuation-in-part of U.S. Design patent application Ser. No. 29/723,678, filed on Feb. 10, 2020, the entirety of which is incorporated herein by reference.

### BACKGROUND OF THE INVENTION

Consumers are continually looking for ways to make quality food at home while reducing the amount of time that it takes to prepare and cook the food. There is currently a trend to make healthy fast food at home. Recent examples of appliances that achieve this include electric pressure cookers and air fryers. Moreover, as people add a greater variety of cooking appliances into their home, space becomes an issue. Thus, there is a continued need in the industry for cooking appliances that have a small footprint, are easy to use, and can make high quality and good tasting food quickly while also being simple to clean after use.

### BRIEF SUMMARY OF THE INVENTION

Exemplary embodiments according to the present disclosure are directed to a cooking apparatus for cooking a food item. The cooking apparatus may include a base component and a lid component. The base component includes a reservoir. The lid component may be alterable between a closed state whereby the lid closes an open top end of the reservoir and an open state whereby the reservoir is exposed. A plurality of cups may be positioned in the reservoir of the base component. Each of the cups may have an internal cavity with a first liquid holding capacity. The reservoir of the base component may have a second liquid holding capacity when the plurality of cups are positioned in the reservoir. The second liquid holding capacity is equal to or greater than the first liquid holding capacity so that one of the cups can be filled with liquid and then the liquid poured from the cup into the reservoir without overflowing the reservoir.

In one aspect, the invention may be cooking apparatus comprising: a base component comprising a reservoir having a floor and an open top end, at least a portion of the floor forming a heating plate that is heated by a heating element when powered; a lid component configured to close the open top end of the reservoir; a plurality of cups positioned in the reservoir of the base component, each of the cups having an internal cavity comprising a first liquid holding capacity; and wherein the reservoir of the base component has a second liquid holding capacity when the plurality of cups are positioned in the reservoir, the second liquid holding capacity being equal to or greater than the first liquid holding capacity.

In another aspect, the invention may be a cooking apparatus comprising: a base component comprising a reservoir having a floor that forms a heating plate that is heated by a heating element when powered; a lid component configured to close the open top end of the reservoir; a plurality of cups positioned in the reservoir of the base component, each of the cups having a closed bottom end and one or more support members extending from the closed bottom end; and wherein the cups are positioned in the reservoir so that the one or more support members of the cups are in contact with the floor of the reservoir and the closed bottom ends of the cups are spaced from the floor of the reservoir, thereby allowing a liquid in the reservoir to flow between the bottom surface of the cups and the floor of the reservoir.

In yet another aspect, the invention may be a cooking apparatus comprising: a base component comprising a reservoir having a floor that forms a heating plate that is heated by a heating element when powered; a lid component pivotably coupled to the base component, the lid component alterable between: (1) an open state wherein the reservoir is exposed; and (2) a closed state wherein the lid component closes an open top end of the reservoir to form a lid-to-base interface; a plurality of cups positioned in the reservoir of the base component, each of the cups comprising a body portion and a handle portion extending from an outer surface of the body portion; and wherein a first portion of the handle portion of each of the cups is located on a first side of the lid-to-base interface and a second portion of each of the cups is located on a second side of the lid-to-base interface such that a plane on which the lid-to-base interface lies intersects the handle portion of each of the cups.

In a further aspect, the invention may be a method of cooking a food item comprising: filling a cup with water; pouring the water from the cup into a reservoir of a base component of a cooking apparatus; positioning one or more of the cups into the reservoir of the base component so that a portion of the cups are in contact with the water and the water does not overflow the reservoir; at least partially filling the one or more cups with an uncooked food item; positioning a lid over the reservoir to close an open top end of the reservoir; and supplying power to a heating element of the cooking apparatus to heat a floor of the reservoir, thereby converting the water in the reservoir to steam that cooks the uncooked food item.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a cooking apparatus in accordance with an embodiment of the present invention with a lid component in a closed state;

FIG. 2 is a perspective view of the cooking apparatus of FIG. 1 with the lid component in an open state exposing a plurality of cups;

FIG. 3 is a cross-sectional view taken along line III-III of FIG. 1;

FIG. 4 is a perspective view of one of the cups of the cooking apparatus of FIG. 1;

FIG. 5 is a side view of the cup of FIG. 4;

FIG. 6 is a perspective view of the cooking apparatus of FIG. 1 with the lid component in the open state and with the cups omitted;

FIG. 7 is the perspective view of FIG. 6 wherein a liquid is being transferred from one of the cups into a reservoir defined by a base component of the cooking apparatus;

FIG. 8 is a perspective view of the cooking apparatus of FIG. 1 wherein the liquid is in the reservoir and a plurality of the cups are filled with a food item and positioned in the reservoir;

FIG. 9 is a perspective view of the cooking apparatus of FIG. 8 with the lid in the closed state and illustrating the cooking apparatus operably coupled to a power source;

FIG. 10 is a cross-sectional view taken along line X-X of FIG. 9;

FIG. 11 is a perspective view of the cooking apparatus of FIG. 1 with the lid in the open state after the food item has been cooked; and

FIG. 12 is a perspective view of a cooking apparatus in accordance with another embodiment of the present invention with the lid component in the open state exposing a single cup in a reservoir.

### DETAILED DESCRIPTION OF THE INVENTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

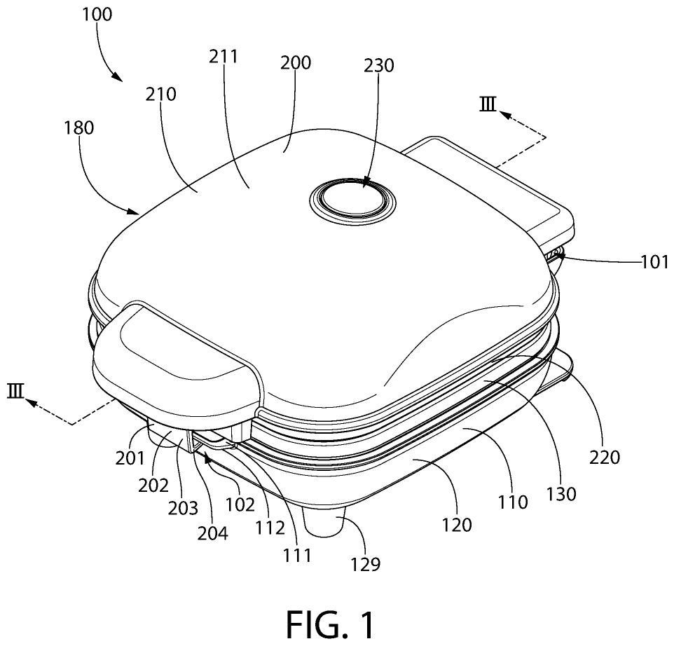

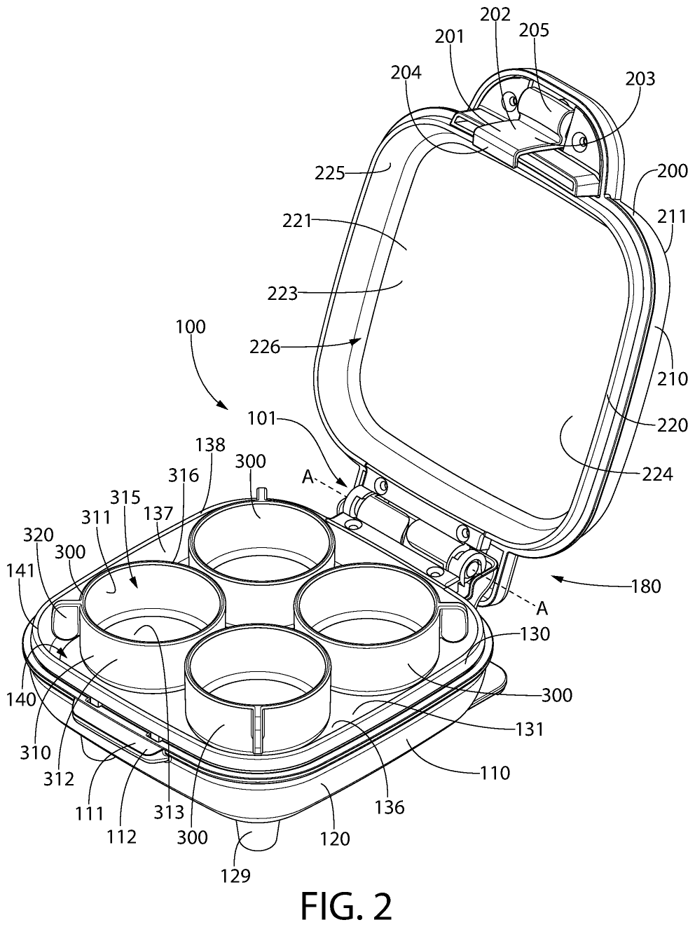

Referring to FIGS. 1-3, a cooking apparatus 100 will be described in accordance with an embodiment of the present invention. The cooking apparatus 100 comprises a housing 180 comprising a base component 110 and a lid component 200. In the exemplified embodiment, the lid component 200 is pivotably coupled to the base component 110. Furthermore, the lid component 200 is alterable between a closed state as shown in FIG. 1 and an open state as shown in FIG. 2. In the closed state, there is no access into the interior of the cooking apparatus 100, which is desirable when the cooking apparatus 100 is being stored and/or used to cook a food item. In the open state, there is access into the interior of the cooking apparatus 100, which is desirable when a user is placing a food item into the interior of the cooking apparatus 100 in preparation for cooking.

As noted above, in the exemplified embodiment the lid component 200 is pivotably coupled to the base component 110. Specifically, the lid component 200 is coupled to the base component 110 by a hinge mechanism 101. Thus, altering the lid component 200 from the closed state to the open state and from the open state to the closed state comprises rotating the lid component 200 relative to the base component 110 about an axis A-A. Thus, in the exemplified embodiment the lid component 200 remains attached to the base component 110 in both the open state and the closed state as well as while it is rotating between the open and closed states. However, the invention is not to be so limited in all embodiments and in other embodiments the lid component 200 may be separate and distinct from the base component 110 when in the open state and then the lid component 200 may be placed onto and coupled to the base component 110 when in the closed state.

The cooking apparatus 100 also comprises a locking mechanism 102 for locking the lid component 200 in the closed state. In the exemplified embodiment, the base component 110 comprises a first locking member 111 and the lid component 200 comprises a second locking member 201, with the first and second locking members 111, 201 collectively forming the locking mechanism 102. In the exemplified embodiment, the first locking member 111 is a tab element 112 protruding from an outer surface of the base component 110. Furthermore, the second locking member 201 is a latch element 202 comprising an arm member 203 extending downwardly from the lid component 200 and a catch member 204 extending from the arm member 203. The latch element 202 is pivotably coupled to the lid component 200 such that actuation of the latch element 202 may be needed to alter the lid component 200 from the closed state to the open state.

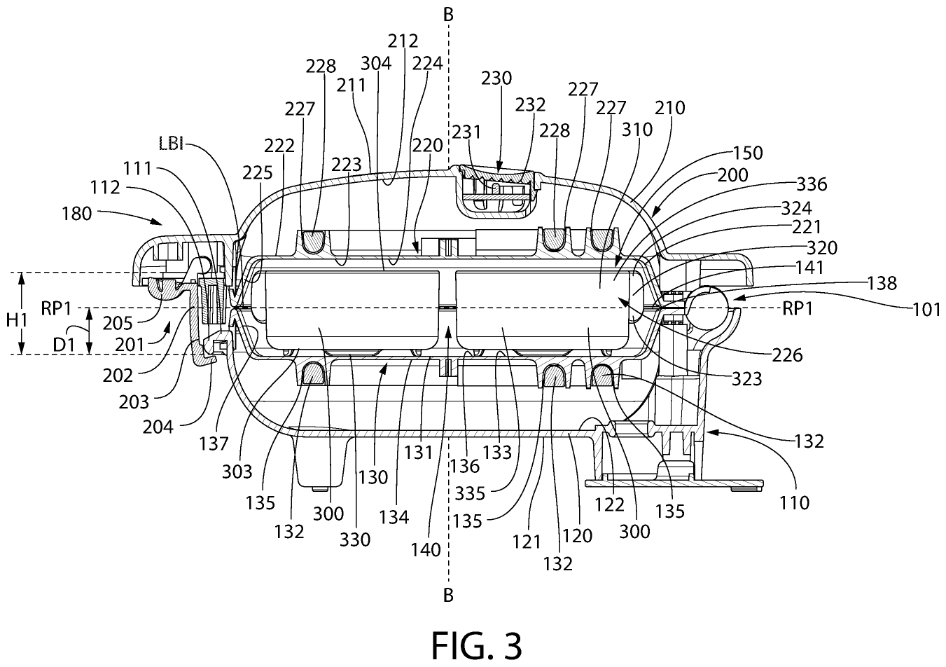

Specifically, when altering the lid component 200 from the open state to the closed state, the latch element 202 will automatically flex outwardly as the catch member 204 passes over the tab element 112. Then, once the catch member 204 has slid past the tab element 112, the latch element 202 will flex back to its original, natural position in which the catch member 204 will engage an underside of the tab element 112. This engagement between the catch member 204 and the tab element 112, as shown in FIG. 3, prevents the lid component 200 from being altered to the open state unless the latch element 202 is first flexed outwardly to disengage the catch member 204 from the tab element 112. Thus, to unlock the locking mechanism 102, a user applies an upward force on a lever portion 205 of the latch element 202, which causes the catch member 204 to disengage from the tab element 112 so that the lid component 200 can be rotated from the closed state to the open state.

The lid component 200 comprises a shell component 210 and a heating component 220. More specifically, the shell component 210 comprises an outer surface 211 that forms a portion of an exposed outer surface of the cooking apparatus 100 and an inner surface 212 opposite the outer surface 211. The inner surface 212 defines a cavity and the heating component 220 is positioned at least partially within the cavity. The shell component 210 may be formed of plastic or a metal with a low heat conductivity so that heat generated by the cooking apparatus 100 is only minimally transferred to the outer surface 211 of the shell component 210 to prevent a user from getting burned when touching the shell component 210 during use of the cooking apparatus 100.

The heating component 220 comprises a heating plate 221 and one or more heating elements 228 coupled to the heating plate 221. The heating plate 221 is coupled to the shell component 210 so that the heating component 220 and the shell component 210 are fixed together. The heating plate 221 may be coupled to the shell component 210 using fasteners such as screws or using adhesive, welding, mechanical engagement, interference or friction fit, or the like. Regardless of the manner in which the heating plate 221 is coupled to the shell component 210, because the heating plate 221 is fixed to the shell component 210, pivoting the lid component 200 between the open and closed states causes the shell component 210 and the heating component 220 to pivot together. The heating plate 221 may be formed from a material, such as a metal, with a high thermal conductivity. For example, in some embodiments the heating plate 221 may be formed from aluminum, although the invention is not to be so limited in all embodiments and other materials such as copper, iron, brass, stainless steel, or the like may be used. Furthermore, the heating plate 221 may be coated with a polytetrafluoroethylene (PTFE) so that the heating plate 221 is a non-stick surface. In other embodiments, the heating plate 221 may be formed from or coated with anodized aluminum, ceramics, silicone, enameled cast iron, or the like for purposes of making it a non-stick surface.

The heating plate 221 comprises an outer surface 222 that faces the shell component 210 and an inner surface 223 opposite the outer surface 222. The inner surface 223 of the heating plate 221 comprises a floor 224 and a sidewall 225 that collectively define a recessed portion 226 of the lid component 200. The outer surface 222 of the heating plate 221 comprises a plurality of channels 227, each of which is configured to receive one of the heating elements 228 therein. Although the heating elements 228 are disposed within channels 227 on the outer surface 222 of the heating plate 221 in the exemplified embodiment, the invention is not to be so limited and the heating elements 228 may be coupled to the heating plate 221 using other techniques in other embodiments. In the exemplified embodiment, the heating elements 228 are in surface contact with the outer surface 222 of the heating plate 221. Thus, when the heating elements 228 are powered, the heat generated by the heating elements 228 is transferred to the heating plate 221 due to thermal conductivity. Thus, as noted above, it is preferable that the heating plate 221 be formed from a material having a high thermal conductivity such as copper, aluminum, brass, or the like to ensure that the heating plate 221 heats up as the heating elements 228 are powered and begin to generate heat.

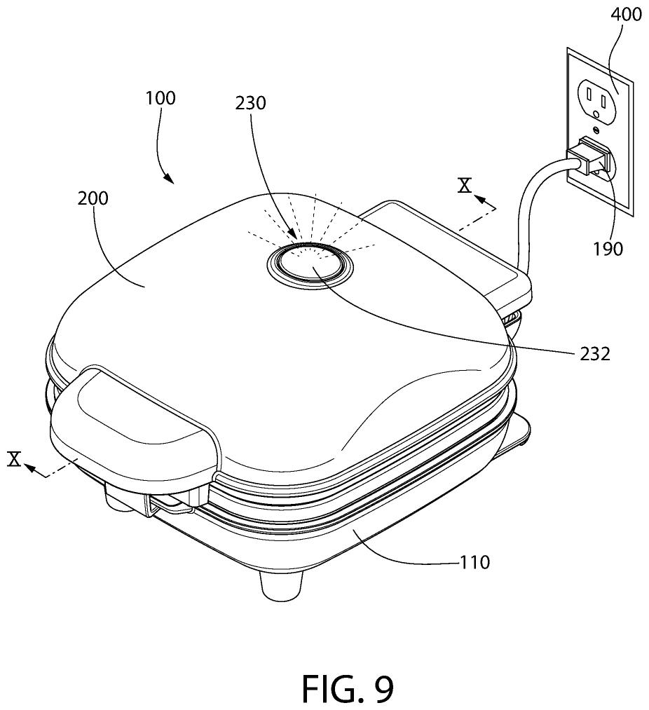

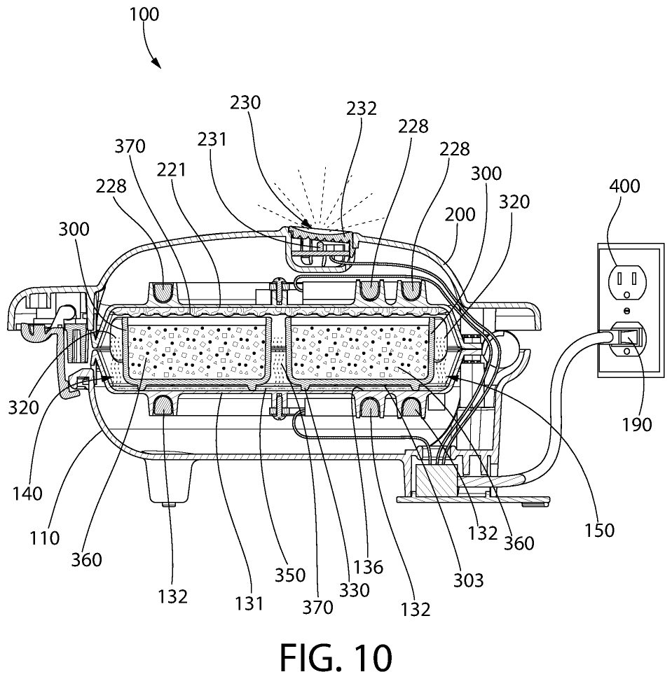

The lid component 200 also comprises a light indicator 230. The light indicator 230 comprises a light source 231 and a light transmissive cover 232 overlying the light source 231. Thus, when activated the light source 231 emits light that passes through the light transmissive cover 232. The light transmissive cover 232 may be fully transparent or it may be translucent and it may have a color for aesthetic enhancement. Additional details about the functionality of the light indicator 230 will be provided below with reference to FIGS. 9 and 10.

Similar to the lid component 200, in the exemplified embodiment the base component 110 comprises a shell component 120 and a heating component 130. The shell component 120 may be formed of a plastic material or any of the materials noted above with reference to the shell component 210. The shell component 120 comprises an outer surface 121 that forms a part of an exposed outer surface of the cooking apparatus 100 and an inner surface 122 opposite the outer surface 121. The inner surface 122 of the shell component 120 defines an interior space within which the heating component 130 is positioned. In the exemplified embodiment, the shell component 120 comprises a plurality of support legs 129 extending from a bottom thereof for supporting the cooking apparatus 100 on a horizontal surface such as a countertop or the like while elevating the bottom of the shell component 120 relative to the horizontal surface. This may prevent burning the horizontal surface in case the shell component 120 gets hot during operation of the cooking appliance 100.

The heating component 130 is fixedly coupled to the shell component 120 in the exemplified embodiment. This may be achieved using fasteners, screws, adhesive, welding, interference fit, friction fit, mechanical engagement, interlocking features, or the like in various different embodiments. Furthermore, the heating component 130 comprises a heating plate 131 and one or more heating elements 132 that are coupled to the heating plate 131. The heating plate 131 may be formed of any of the materials described above for the heating plate 221 of the lid component 200. Thus, for example, the heating plate 131 may be formed from aluminum, brass, copper, iron, or other materials with a high thermal conductivity so that heat generated by the heating element 132 will heat the heating plate 131 as described herein. The heating plate 131 comprises an inner surface 133 and an outer surface 134, with the outer surface 134 facing the shell component 120. In the exemplified embodiment, the heating plate 131 comprises a plurality of channels 135 formed therein, and one of the heating elements 132 is disposed within each of the channels 135 to couple the heating elements 132 to the heating plate 131. Of course, the heating elements 132 may be coupled to the heating plate 131 in other ways and using other techniques in other embodiments. The heating elements 132 may be in contact with the heating plate 131 so that heat generated by the heating elements 132 heats the heating plate 131 via thermal conductivity.

The inner surface 133 of the heating plate 131 comprises a floor 136 and a sidewall 137 that collectively define a reservoir 140 of the base component 110. The reservoir 140 of the base component 110 has an open top end 141 that is closed when the lid component 200 is in the closed state, as shown in FIG. 3. The reservoir 140 is the portion of the cooking apparatus 100 within which food is cooked during use of the cooking apparatus 100 as described herein.

As shown in FIG. 3, when the lid component 200 is in the closed state, a lid-to-base interface LBI is formed where the lid component 200 contacts the base component 110. More specifically, in this embodiment the lid-to-base interface LBI is formed where the heating plate 131 of the base component 110 contacts the heating plate 221 of the lid component 200. The lid-to-base interface LBI is located along the open top end 141 of the reservoir 140 of the base component 140. Furthermore, the lid-to-base interface LBI (and the open top end 141 of the reservoir 140 of the base component 140) lie along a reference plane RP1, which will be discussed again later on in this document. Furthermore, when the lid component 200 is in the closed state, the reservoir 140 of the base component 110 and the recessed portion 226 of the lid component 200 collectively form a cooking cavity 150 of the cooking apparatus 100 within which food items may be cooked by heat transmitted from the heating elements 132, 228 to the heating plates 131, 221, respectively.

When the cooking apparatus 100 is assembled as shown in the drawings, the heating elements 228, 132 and the outer surfaces 222, 134 of the heating plates 131, 221 are not visible or exposed. Rather, with the lid in the open state as shown in FIG. 2, the floor 224 and sidewall 225 of the recessed portion 226 of the lid component 200 and the floor 136 and sidewall 137 of the reservoir 140 of the base component 110 are visible and exposed. All of the electronic components are hidden in the space between the heating plate 221 and the shell component 210 of the lid component 200 and between the heating plate 131 and the shell component 120 of the base component 110. This makes the cooking apparatus 100 aesthetically pleasing to a consumer. Furthermore, the shell components 120, 210 of the base and lid components 110, 200 may comprise colors or designs thereon to further enhance the aesthetics of the cooking apparatus 100.

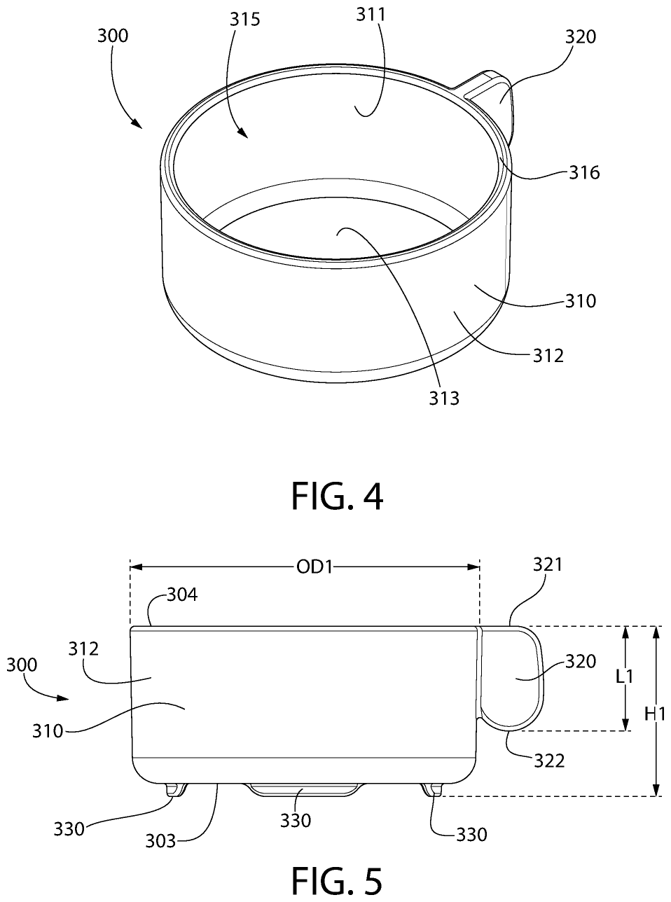

Referring to FIGS. 2-5, the cooking apparatus 100 further comprises a plurality of cups 300 that are configured to be positioned in the reservoir 140 of the base component 110 to cook food items in the cups 300. In the exemplified embodiment, each of the cups 300 is formed from silicone. However, other materials can be used in other embodiments including plastic, metal, and the like. Silicone may be preferable in some embodiments due to its flexibility, which may make it easier to remove the food item therefrom after cooking with the cooking apparatus 100 as described herein. In some embodiments, the cups 300 may be formed from a flexible material having a low thermal conductivity, such as elastomers, rubbers, or the like. Each of the cups 300 comprises a body portion 310 having an inner surface 311 and an outer surface 312 and a handle portion 320 extending from the outer surface 312. The body portion 310 comprises an internal cavity 315 that is defined by the inner surface 311 and a floor 313. The body portion 310 is configured to hold a food item and/or a liquid in the internal cavity 315.

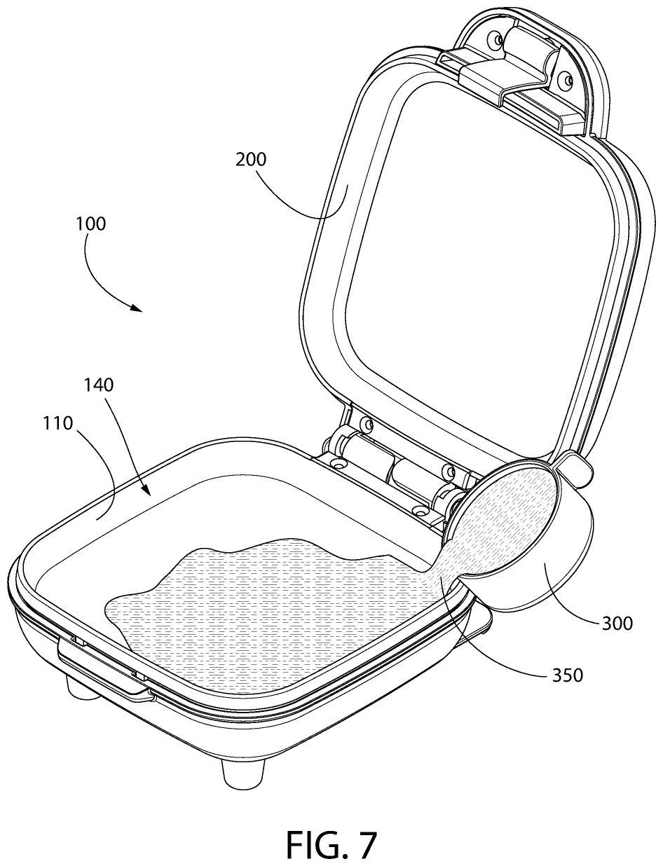

In the exemplified embodiment, each of the cups 300 has a first liquid holding capacity, which is an amount of a liquid that can be placed into the internal cavity 315 of the cup 300 without the liquid overflowing the internal cavity 315 of the cup 300 and pouring out of an open top end 316 of the internal cavity 315. Stated another way, the internal cavity 315 of each of the cups 300 has a first volume. As will be described in detail with reference to FIG. 7, the cooking apparatus 100 is intended to hold an amount of a liquid located in the reservoir 140 of the base component 110 and to heat up the liquid in the reservoir 140 and convert it to steam that cooks the food item in the cups 300. Thus, one of the cups 300 can be used to introduce a liquid (e.g., water) into the reservoir 140 prior to use of the cooking apparatus 100 to cook a food item. For this reason, the holding capacity of the cups 300 as compared to the holding capacity of the reservoir 140 when all of the cups 300 are located in the reservoir 140 is one feature of the invention that will be described herein.

The cups 300 comprise a closed bottom end 303 and a top end 304 which forms the open top end 316 of the internal cavity 315. Furthermore, the cups 300 comprise one or more support members 330 extending from the closed bottom end 303. In the exemplified embodiment, there are a plurality of the support members 330 arranged in a circumferentially spaced apart manner about a loop or loop configuration. Thus, in the exemplified embodiment each of the support members 330 is a protuberance having an arcuate shape that extends from the closed bottom end 303 of the cup 300. When the cups 300 are positioned in the reservoir 140 of the base component 110 as shown in FIG. 3, the support members 330 are in contact with the floor 136 of the reservoir 140 and the closed bottom end 303 is spaced apart from the floor 136. As a result, any liquid in the reservoir 140 will be able to flow between the closed bottom end 303 of the cups 300 and the floor 136 of the reservoir 140 to rapidly cook any food items contained in the cups 300.

The reservoir 140 of the base component 110 is sized and configured so that four of the cups 300 can be positioned therein at one time. Specifically, as shown in FIG. 2, four of the cups 300 can be positioned in the reservoir 140 in a two-by-two matrix arrangement. In the exemplified embodiment, no more than four of the cups 300 can be made to simultaneously fit within the reservoir 140 of the base component 110. In some embodiments, the cooking apparatus 100 may be considered a kit that includes the housing 180 comprising the base component 110 and the lid component 200 and four of the cups 300 disposed within the housing 180 as described herein.

The cups 300 have an outer diameter OD1 and a height H1 measured from a distal-most end of the support members 330 to the top end 304. In the exemplified embodiment, a ratio of the outer diameter OD1 to the height H1 is at least 2:1. In some embodiments, the ratio of the outer diameter OD1 to the height H1 is approximately 2:1 (i.e., between 1.9:1 and 2.1:1). Thus, the cups 300 are approximately twice as wide as they are tall.

In the exemplified embodiment, the height H1 of the cups 300 is greater than a depth D1 of the reservoir 140 of the base component 110 measured from the floor 136 of the reservoir 140 to the open top end 141. As a result, the cups 300 protrude from the open top end 141 of the reservoir 140 when positioned in the reservoir 140 with the support members 330 in contact with the floor 136 of the reservoir 140. Thus, when the cups 300 are positioned in the reservoir 140, a first portion 335 of the cups 300 is located within the reservoir 140 between the open top end 141 and the floor 136 and a second portion 336 of the cups 300 protrudes from the open top end 141 of the reservoir 140. When the lid component 200 is in the closed state, the second portion 336 of the cups 300 extend into the recessed portion 226 of the lid component 200. Thus, the reference plane RP1-RP1 on which the open top end 141 of the reservoir 140 and the lid-to-base interface LBI lie intersects the cups 300. Furthermore, when the lid component 200 is in the closed state, the floor 224 of the heating plate 221 of the heating component 220 of the lid component 200 is spaced from the top end 304 of the cups 300 by a gap so that the lid component 200 does not contact the cups 300 and distort them in any way. Thus, the height of the cooking cavity 150 is greater than the height H1 of the cups 300.

In the exemplified embodiment, the handle portion 320 of the cups 300 does not extend the full height of the cups 300. Rather, the handle portion 320 extends from a top edge 321 that is flush with the top end 304 of the body portion 310 of the cups 300 to a bottom edge 322 that is located between the top end 304 and the closed bottom end 303 of the cups 300. The handle portion 320 may have a length L1 measured from the top edge 321 to the bottom edge 322 with the length L1 being less than the height H1 of the cups but greater than one-half of the height H1 of the cups 300. The handle portion 320 may extend the full height of the cups 300 in alternative embodiments. In some embodiments a ratio of the height H1 of the cups 300 to the length L1 of the handle portion 320 may be between 1.4:1 and 1.7:1.

By having the handle portion 320 extend greater than one-half of the height H1 of the cups 300, a first portion 323 of the handle portion 320 is located in the reservoir 140 of the base component 110 and a second portion 324 of the handle portion 320 is located in the recessed portion 226 of the lid component 110. Stated another way, the plane RP1 on which the open top end 141 of the reservoir 140 and on which the lid-to-base interface LBI lie intersects the handle portion 320 of each of the cups 300.

The benefit of this is two-fold. First, it ensures that the second portion 324 of the handle portion 320 protrudes above a top edge 138 of the sidewall 137 of the reservoir 140, thereby making it available to be grasped by a user without the user having to place his/her fingers into the reservoir 140. This will prevent the user from getting burned by the heating plate 131 when the user is removing the cups 300 from the reservoir 140 after cooking the food items contained therein. Second, by having the first portion 323 of the handle portion 320 located below the top edge of the sidewall 137 and therefore located within the reservoir 140, it ensures that the handle portion 320 will not protrude beyond the inner surface of the sidewall 137 so long as the support members 330 are in contact with the floor 136 of the reservoir 140. Specifically, if the entire handle portion 320 was located above the top edge of the sidewall 137, then the handle portion 320 would extend outwardly beyond the sidewall 137 if the cup 300 were placed too close to the sidewall 137. This would cause the lid component 200 to contact the handle portion 320 when being closed, thereby preventing the lid component 200 from being easily altered into the closed state. By having the first portion 323 of the handle portion 320 located in the reservoir 340, the handle portion 320 will abut the sidewall 137 but will not protrude beyond the sidewall 137 in a radial direction relative to a vertical axis B-B that intersects the base component 110, the lid component 200, and the cooking cavity 150. Thus, as long as the support members 330 (or the bottom end 303) of the cups 300 are in contact with the floor 136 of the reservoir 140, the handle portions 320 of the cups 300 will not interfere with the closing of the lid component 200.

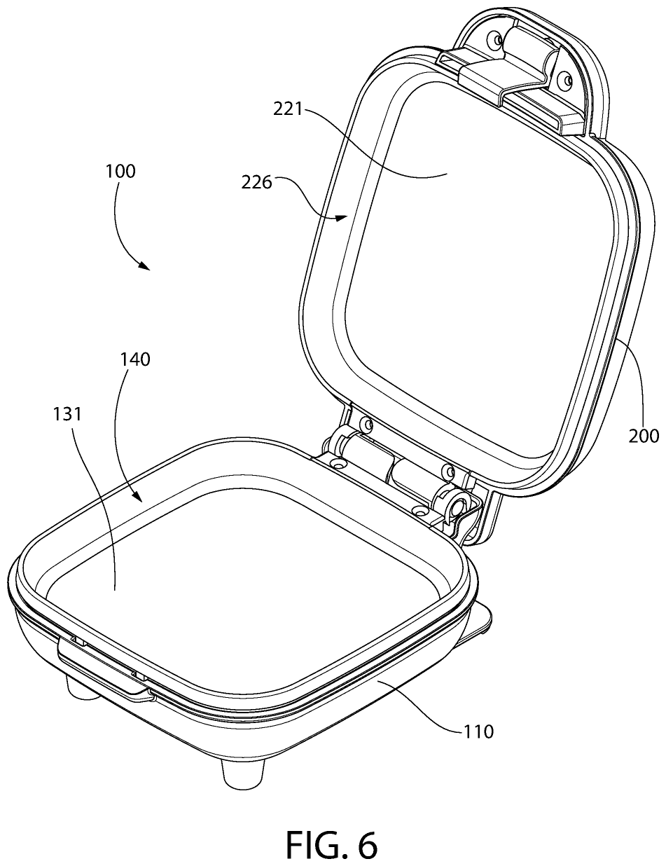

Referring to FIGS. 6-11 sequentially, a method of using the cooking apparatus 100 will be described in accordance with an embodiment of the present invention. FIG. 6 illustrates the cooking apparatus 100 with the lid component 200 in the open state and with the cups 300 omitted. Thus, the reservoir 140 of the base component 110 and the recessed portion 226 of the lid component 200 are exposed. With the lid component 200 in the open state, a user can add a liquid into the reservoir 140 and place the cups 300 with food therein into the reservoir 140 prior to altering the lid component 200 into the closed state for cooking of the food in the cups 300.

Turning to FIG. 7, when a user desires to cook food with the cooking apparatus 100, the first step is to introduce a liquid (e.g., water) into the reservoir 140 of the base component 100. In the exemplified embodiment, this is accomplished by filling the internal cavity 315 of one of the cups 300 with water 350 and then transporting the water 350 from the cup 300 to the reservoir 140. Specifically, a user can pour the water 350 from the cup 300 into the reservoir 140 to partially fill the reservoir 140 with the water 350.

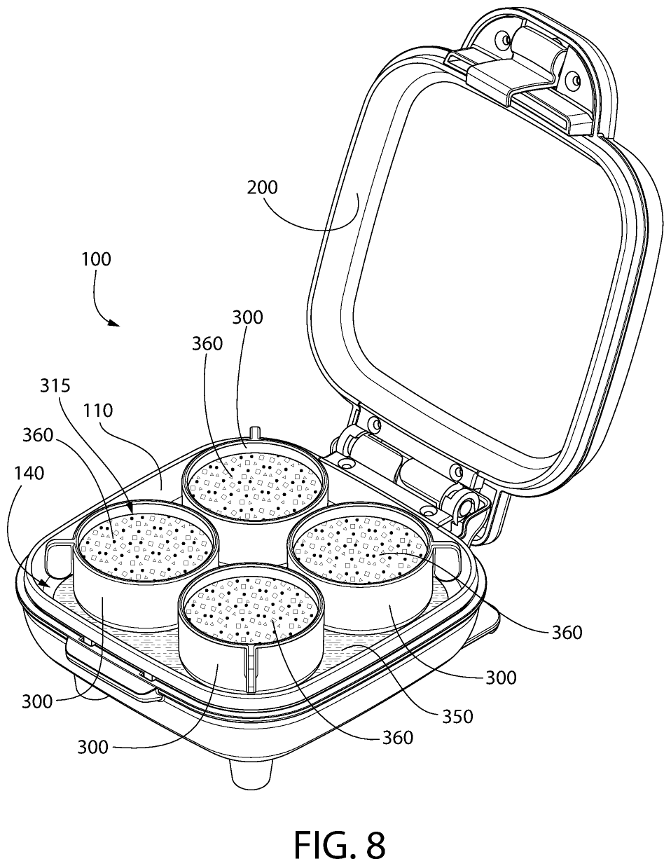

As mentioned above, the internal cavity 315 of each of the cups 300 has a first liquid holding capacity, which is a measure of the internal cavity's ability to hold a substance such as water. In other aspects, the internal cavity 315 may have a first volume. The reservoir 140 of the base component 110 of the cooking apparatus 100 has a second liquid holding capacity when the plurality of cups 300 are all positioned in the reservoir 140. Specifically, the reservoir 140 of the base component 110 may have a third liquid holding capacity when none of the cups 300 are positioned in the reservoir 140. However, when the cups 300 are positioned in the reservoir 140, the liquid holding capacity of the reservoir 140 is reduced by the space taken up by the cups 300. Thus, the second liquid holding capacity is an amount of the liquid (e.g., water) that can be placed into the reservoir 140 of the base component 110 while the plurality of cups 300 are all positioned in the reservoir 140 (see FIG. 8) without the liquid overflowing the reservoir 140 and pouring out of the open top end 141 of the reservoir 140. Stated another way, the reservoir 140 has a second volume when the cups 300 are all positioned in the reservoir 140, the second volume being the volume of the reservoir 140 minus the volume of the portions of each of the cups 300 that are located in the reservoir 140.

In the exemplified embodiment, the second liquid holding capacity of the reservoir 140 of the base component 110 when all of the cups 300 are positioned therein is greater than the first liquid holding capacity of the internal cavity 315 of each of the cups 300 (or the second volume of the reservoir 140 with the cups 300 therein is greater than the first volume of the internal cavity 315 of the cups 300). More specifically, in the exemplified embodiment a ratio of the second liquid holding capacity of the reservoir 140 of the base component 110 when all of the cups 300 are positioned therein to the first liquid holding capacity of the internal cavity 315 of the cups 300 is at least 2:1, or at least 3:1. Thus, one of the cups 300 can be filled with water at least two (or three) times with the water then being introduced (or poured) into the reservoir 140 without overflowing the reservoir 140 even when all four of the cups 300 are positioned in the reservoir 140, as shown in FIG. 8. This allows for the cooking apparatus 100 to be a truly stand-alone apparatus that does not require any other components for operation (other than a power source, a water source, and the food to be cooked). A user need not get a measuring cup or other device to introduce the water into the reservoir 140, but can use one of the cups 300 that forms a part of the cooking apparatus 100 to introduce the correct amount of water into the reservoir 140 prior to use. It should be appreciated that in some embodiments only one cup 300 full of water is needed to be introduced into the reservoir 140 to facilitate proper operation of the cooking apparatus 100 to cook a food item.

Turning to FIG. 8, the cooking apparatus 100 is illustrated with the lid component 200 in the open state. In FIG. 8, the water 350 that was introduced from the cup 300 into the reservoir 140 in FIG. 7 is shown located in the reservoir 140. Furthermore, in FIG. 8 the four cups 300 are positioned in the reservoir 140. Each of the four cups 300 has been filled with a food item 360. In some embodiments, the food item 360 may be eggs alone or mixed with vegetables, meat, cheese, or the like. In other embodiments, the food item 360 may be cheesecake ingredients, custard ingredients, or the ingredients used to make other desserts. Thus, although egg bites may be made using the cooking apparatus 100 in some embodiments, other types of edible products can be cooked and made using the cooking apparatus 100 in other embodiments.

Notably, in FIG. 8 all four of the cups 300 are filled with the food item 360 and positioned in the reservoir 140 of the base component 110 on top of the water 350 that was poured from one of the cups 300 into the reservoir 140. As can be seen, the water 350 does not overflow the reservoir 140. This is because, as noted above, the second liquid holding capacity of the reservoir 140 with the four cups 300 therein is greater than the first liquid holding capacity of the internal cavity 315 of the cups 300.

Next, referring to FIG. 9, the lid component 200 is altered from the open state to the closed state and an electric plug 190 of the cooking apparatus 100 is coupled to a wall outlet 400 that is coupled to a power source. Of course, it should be appreciated that the electric plug 190 could be coupled to the wall outlet 400 prior to introducing the water 350 into the reservoir 140 and prior to positioning the cups 300 in the reservoir 140. In fact, it may reduce the amount of time that it takes to cook a particular food item if the plug 190 is plugged into the wall outlet 400 before introducing the water 350 into the reservoir 140 so that the heating elements 132, 228 can begin to heat.

Moreover, although in the exemplified embodiment the cooking apparatus 100 includes the electric plug 190, in other embodiments the cooking apparatus 100 may receive power in other ways. For example, the cooking apparatus 100 may comprise an internal power source such as a plurality of batteries for powering the heating elements 132, 228. In such an embodiment, the cooking apparatus 100 may include a power button for powering the cooking apparatus 100 on and off. In the exemplified embodiment, there is no such power button. Rather, in the exemplified embodiment upon plugging the electric plug 190 into the wall outlet 400, power is automatically transmitted to the heating elements 132, 228 so that the heating elements 132, 228 can begin to generate heat.

Furthermore, once the electric plug 190 is plugged into the wall outlet 400, the light indicator 230 is activated. Specifically, the light source 231 of the light actuator 230 is activated to emit light through the light transmissive cover 232 of the light indicator 230 to indicate to the user that the heating elements 132, 228 are powered and heating up. In some embodiments, the light indicator 230 may be activated when the heating elements 132, 228 are heating up and, upon the heating elements 132, 228 reaching their maximum temperature, the light indicator 230 may be deactivated. However, even after the heating elements 132, 228 reach their maximum temperature, the heating elements 132, 228 will continue to emit heat until the electric plug 190 is detached from the wall outlet 400 despite the light indicator 230 being deactivated. Thus, the light indicator 230 may be activated to illuminate light when the heating elements 132, 228 are in a heating-up mode, and may deactivate upon the heating elements 132, 228 reaching maximum temperature even though the heating elements 132, 228 will continue to emit heat even after reaching maximum temperature so long as the electric plug 190 is plugged into the wall outlet 400. In an alternative embodiment, the light indicator 230 may be activated to illuminate light as long as the cooking apparatus 100 is powered via the electric plug 190 being coupled to the wall outlet 400.

FIG. 10 is a cross-sectional view of the cooking apparatus 100 when the cooking apparatus 100 is operating and cooking the food item 360 in the cups 300 that are located in the reservoir 140 of the base component 110. Thus, in FIG. 10 the electric plug 190 is plugged into the wall outlet 400. Furthermore, in this view electrical conductors (i.e., wires) can be seen operably coupled to the power source (i.e., wall outlet 400) and to the light source 231 of the light indicator 230, the heating elements 132 of the base component 110, and the heating elements 228 of the lid component 200. Thus, with the electric plug 190 plugged into the wall outlet 400 and thereby operably coupled to a power source, the light indicator 230 is activated to emit light and the heating elements 132, 228 are activated to generate heat.

As seen in FIG. 10, the water 350 is located in the reservoir 140 to at least partially cover the floor 136 of the reservoir 140. In some embodiments, it may be preferable for a sufficient amount of water to be introduced into the reservoir 140 so that an entirety of the floor 136 of the reservoir 140 is covered with the water when the four cups 300 are positioned in the reservoir 140. In the exemplified embodiment, introducing a single cup full of water into the reservoir 140 will achieve this end. As noted above, the cups 300 are positioned in the reservoir 140 so that the support members 330 thereof are in contact with the floor 136 of the reservoir 140 and the bottom ends 303 of the cups 300 are spaced from the floor 136. Thus, the water 350 in the reservoir 140 will flow in the space between the bottom ends 303 of the cups 300 and the floor 136 of the reservoir 140. This ensures that the heat generated by the heating plate 131 heats the water 350, which in turn heats the food item 360.

Moreover, as the heating plates 131, 221 are heated by the heating elements 132, 228, the heating plates 131, 221 heat the water 350 to boiling so that the water 350 is converted to steam 370. The steam 370 may then heat the food item 360 uniformly as the steam 370 fills in the cooking cavity 150. Generally, the food item 360 will be fully cooked when the water 350 in the reservoir 140 has completely evaporated.

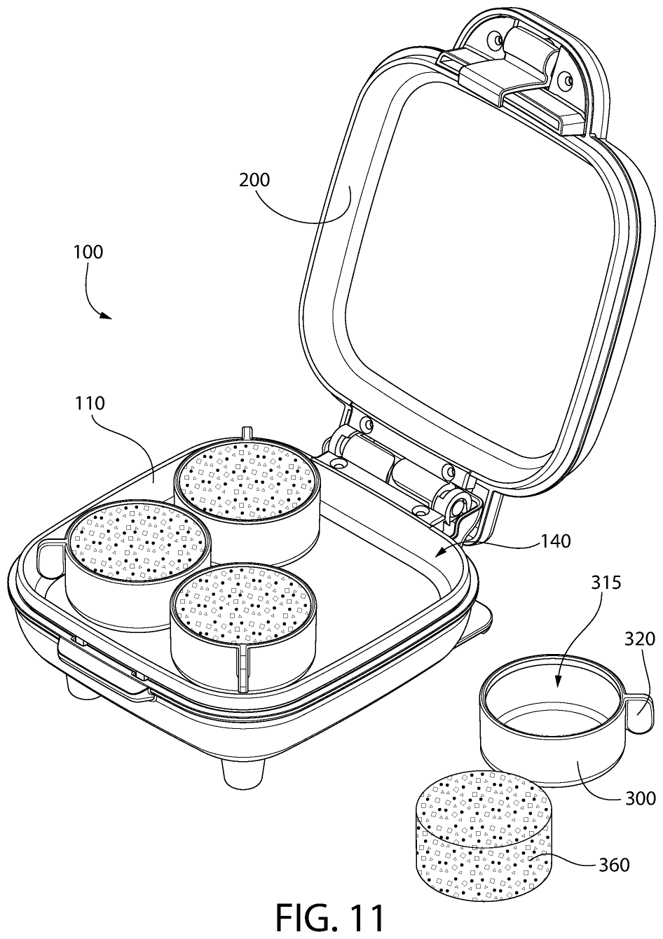

Referring to FIG. 11, upon a cooking time expiring such that the food item 360 is fully cooked, a user can unplug the electric plug from the wall outlet and alter the lid component 200 from the closed state to the open state. The user may then grip the handle portion 320 of the cups 300 and remove the cups 300 from the reservoir 140. Finally, the user can turn the cups 300 upside-down so that the food item 360 can be removed from the internal cavity 315 of the cups 300. As seen in FIG. 11, all of the water that was previously in the reservoir 140 has evaporated, which makes for a very easy clean-up. The user may simply wipe down the interior surfaces of the cooking appliance 100 and clean the cups 300 with dish soap and water in a conventional manner.

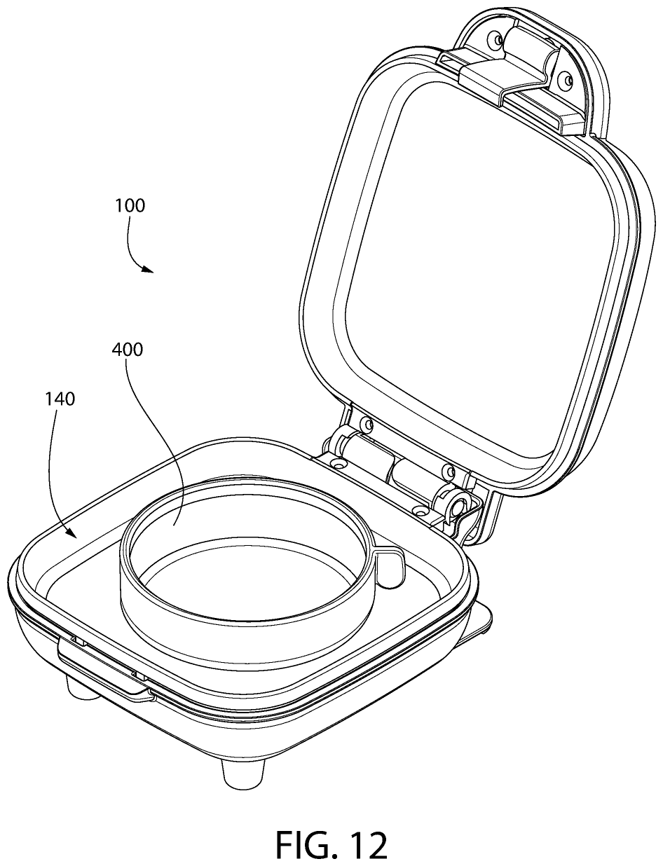

Referring to FIG. 12, the cooking apparatus 100 shown in the previous figures is depicted, but with a single large cup 400 positioned in the reservoir 140. Thus, in some embodiments instead of having four of the cups 300, a single large cup 400 may fit within the reservoir 140 to make a larger food item.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1. A cooking apparatus comprising:
a base component comprising a reservoir having a floor and an open top end, at least a portion of the floor forming a heating plate that is heated by a heating element when powered;
a lid component configured to close the open top end of the reservoir;
a plurality of cups positioned in the reservoir of the base component, each of the cups having an internal cavity comprising a first liquid holding capacity; and
wherein the reservoir of the base component has a second liquid holding capacity when the plurality of cups are positioned in the reservoir, the second liquid holding capacity being equal to or greater than the first liquid holding capacity.

2. The cooking apparatus according to claim 1 wherein the first liquid holding capacity is an amount of a liquid that can be placed into the internal cavity of the cups without the liquid overflowing the internal cavity of the cups and pouring out of an open top end of the internal cavity, and wherein the second liquid holding capacity is an amount of the liquid that can be placed into the reservoir while the plurality of cups are positioned in the reservoir without the liquid overflowing the reservoir and pouring out of the open top end of the reservoir.

3. The cooking apparatus according to claim 1 wherein the lid component comprises a recessed portion having a floor that forms a second heating plate that is heated by a second heating element when powered.

4. The cooking apparatus according to claim 3 wherein the lid component is alterable between an open state wherein the lid component does not close the open top end of the reservoir of the base component and a closed state wherein the lid component closes the open top end of the reservoir of the base component, and wherein in the closed state the reservoir of the base component and the recessed portion of the lid component collectively form a cooking cavity within which the cups are positioned, and wherein a first portion of each of the plurality of cups is positioned in the reservoir of the base component and a second portion of each of the plurality of cups extends into the recessed portion of the lid component.

5. The cooking apparatus according to claim 1 wherein the reservoir of the base component has a depth measured from the floor to the open top end and wherein each of the cups has a bottom end, a top end, and a height measured from the bottom end to the top end, the height of each of the cups being greater than the depth of the reservoir.

6. The cooking apparatus according to claim 1 wherein each of the cups comprises a body portion comprising an inner surface that defines the internal cavity and an outer surface and a handle portion extending from the outer surface of the body portion.

7. The cooking apparatus according to claim 6 wherein when the cups are positioned in the reservoir of the base component, a first portion of the handle portion of each of the cups is located within the reservoir of the base component and a second portion of the handle portion of each of the cups is located outside of the reservoir of the base component such that a plane on which the open top end of the reservoir lies intersects the handle portion of each of the cups.

8. The cooking apparatus according to claim 1 wherein each of the cups is formed from silicone.

9. The cooking apparatus according to claim 1 wherein each of the cups comprises a closed bottom end and one or more support members extending from the closed bottom end so that when the cups are positioned in the reservoir the one or more support members of the cups are in contact with the floor of the reservoir and the closed bottom ends of the cups are spaced from the floor of the reservoir, thereby allowing a liquid in the reservoir to flow between the closed bottom ends of the cups and the floor of the reservoir.

10. The cooking apparatus according to claim 1 wherein the reservoir is sized and configured so that four of the cups can be simultaneously positioned in the reservoir in a two-by-two matrix arrangement.

11. The cooking apparatus according to claim 1 wherein the second liquid holding capacity is at least three times greater than the first liquid holding capacity.

12. The cooking apparatus according to claim 1 wherein the lid component is pivotably coupled to the base component so as to be pivotable between an open state wherein the open top end of the reservoir is exposed and a closed state whereby the lid closes the open top end of the reservoir.

13. The cooking apparatus according to claim 1 further comprising a light indicator on an outer surface of the lid component, wherein upon powering the heating element the light indicator is activated to emit light, and wherein upon the heating element reaching a maximum temperature the light indicator is deactivated and no longer emits light, and wherein after the light indicator is deactivated the heating element continues to emit heat to heat the heating plate until powered off by a user.

14. A cooking apparatus comprising:
a base component comprising a reservoir having a floor that forms a heating plate that is heated by a heating element when powered;
a lid component configured to close the open top end of the reservoir;
a plurality of cups positioned in the reservoir of the base component, each of the cups having a closed bottom end and one or more support members extending from the closed bottom end; and
wherein the cups are positioned in the reservoir so that the one or more support members of the cups are in contact with the floor of the reservoir and the closed bottom ends of the cups are spaced from the floor of the reservoir, thereby allowing a liquid in the reservoir to flow between the bottom surface of the cups and the floor of the reservoir.

15. The cooking apparatus according to claim 14 wherein each of the cups comprises a body portion comprising an inner surface and an outer surface and a handle portion extending from the outer surface.

16. The cooking apparatus according to claim 15 wherein when the cups are positioned in the reservoir of the base component, a first portion of the handle portion of each of the cups is located within the reservoir of the base component and a second portion of the handle portion of each of the cups protrudes from an open top end of the reservoir of the base component such that a plane on which the open top end of the reservoir lies intersects the handle portion of each of the cups.

17. The cooking apparatus according to claim 14 wherein the one or more support members comprises a plurality of protuberances extending from the closed bottom end of the cups and arranged in a spaced apart manner, each of the protuberances being arcuate and the protuberances being collectively arranged along a loop.

18. The cooking apparatus according to claim 14 wherein each of the cups has an outer diameter and a height measured from a distal end of the one or more support members to a top end of the cup, a ratio of the outer diameter to the height being at least 2:1.

19. The cooking apparatus according to claim 14 wherein the reservoir is sized and configured so that four of the cups can be positioned therein at one time in a two-by-two matrix arrangement, and wherein no more than four of the cups can simultaneously fit within the reservoir.

20. A cooking apparatus comprising:
a base component comprising a reservoir having a floor that forms a heating plate that is heated by a heating element when powered;
a lid component pivotably coupled to the base component, the lid component alterable between: (1) an open state wherein the reservoir is exposed; and (2) a closed state wherein the lid component closes an open top end of the reservoir to form a lid-to-base interface;
a plurality of cups positioned in the reservoir of the base component, each of the cups comprising a body portion and a handle portion extending from an outer surface of the body portion; and
wherein a first portion of the handle portion of each of the cups is located on a first side of the lid-to-base interface and a second portion of each of the cups is located on a second side of the lid-to-base interface such that a plane on which the lid-to-base interface lies intersects the handle portion of each of the cups.

21. (canceled)
